(19) United States
(12) Patent Application Publication
(10) Pub. No.: US 2008/0165284 A1
(43) Pub. Date: Jul. 10, 2008

(54) ANTENNA MEMBER AND DIGITAL TV RECEIVER USING SAME

(75) Inventors: WEN-PIN YANG, Hsinchu (TW); FAN-HSI KUNG, Hsinchu (TW)

Correspondence Address: PCE INDUSTRY, INC.;ATT. CHENG-JU CHIANG, 458 E. LAMBERT ROAD, FULLERTON, CA, 92835, US

(73) Assignee: FITIPOWER INTEGRATED TECHNOLOGY, INC, Hsinchu (TW)

(21) Appl. No.: 11/937,346

(22) Filed: Nov. 8, 2007

(30) Foreign Application Priority Data
Jan. 5, 2007 (TW) 096100533

(51) Int. Cl. H04N 3/27; H04N 5/50

(52) U.S. Cl. 348/554; 348/731; 348/E03.049; 348/E05.097

(57) ABSTRACT

An antenna member (120) includes a main body (122), a receiver (121) extending from the main body configured for receiving TV signals, an infrared receiver (123) arranged in the main body configured for receiving remote control signals sent out from a remote device.

### BACKGROUND

1. Field of the Invention

The present invention relates to antenna members, more particularly, to an antenna member having a capability of receiving remote control signals and a digital TV receiver using the antenna member.

2. Description of Related Art

Computers are popular because of their multifarious functions. The computers now can be used to receive and display TV programs through a digital TV receiver. The digital TV receiver is configured for receiving TV signals and the computer is configured for displaying the TV programs.

A conventional digital TV receiver includes a TV tuner and an antenna member connected with the TV tuner. The antenna member is generally arranged to be visible, such as the top of the display of the computer, to be configured for receiving the TV signals and transmitting the received TV signals to the TV tuner. The TV tuner processes the TV signals and transmits the signals to the computer to be displayed.

The conventional digital TV receiver may further include an infrared receiver, integrated into the TV tuner, so as to receive remote control signals sent out from the appropriate remote device.

The TV tuner can be connected with a host computer through a USB interface or inserted directly into a PCI connector on the motherboard. If the TV tuner uses a USB interface located in the back of the host computer or if the TV tuner is inserted directly into the PCI connector, the infrared receiver may not clearly receive the signaling commands from the remote control signals because the host computer may partially block the path of the remote control signals. Therefore, the digital TV receiver may not respond to all of the remote control signals, more particularly, the digital TV receiver may not respond to any commands from the remote control signals.

What is needed, therefore, is an antenna member having an excellent capability of receiving remote control signals and a digital TV receiver using the antenna member.

### SUMMARY

An antenna member according to a preferred embodiment, includes a main body, a receiver extending from the main body configured for receiving TV signals, an infrared receiver arranged in the main body configured for receiving remote control signals sent out from a remote device.

A digital TV receiver according to a preferred embodiment, includes a TV tuner, a RF cable, an antenna member electrically connecting to the TV tuner through the RF cable. The antenna member includes a main body, a receiver extending from the main body configured for receiving TV signals and transmitting the TV signals to the TV tuner through the RF cable, an infrared receiver arranged in the main body configured for receiving remote control signals sent out from a remote device.

Other advantages and novel features of the present invention will become more apparent from the following detailed description of preferred embodiment when taken in conjunction with the accompanying drawings.

### BRIEF DESCRIPTION OF THE DRAWINGS

Many aspects of the present antenna member can be better understood with reference to the following drawings. The components in the drawings are not necessarily to scale, the emphasis instead being placed upon clearly illustrating the principles of the present antenna member. Moreover, in the drawings, like reference numerals designate corresponding parts throughout the several views.

FIG. 1 is a schematic view of a digital TV receiver according to a preferred embodiment of the present invention;

FIG. 2 is a circuit diagram of the digital TV receiver of FIG. 1; and

FIG. 3 is another circuit diagram of the digital TV receiver of FIG. 1.

### DETAILED DESCRIPTION OF THE INVENTION

Reference will now be made to the drawings to describe a preferred embodiment of the present antenna member in detail.

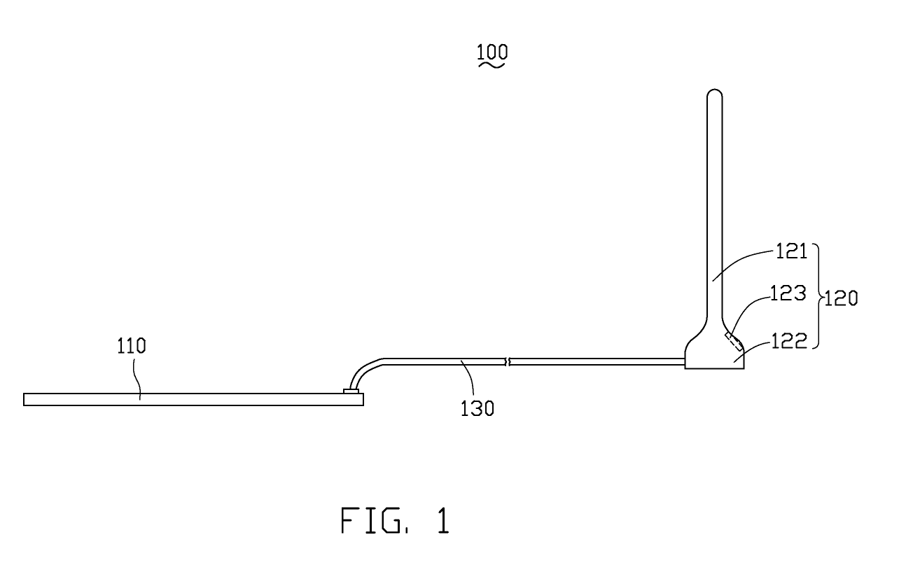

Referring to FIG. 1, a digital TV receiver 100 in accordance with a preferred embodiment, includes a TV tuner 110, an antenna member 120 and a RF (radio frequency) cable 130 connected with the TV tuner 110 and the antenna member 120.

The TV tuner 110 may be a printed circuit board having integrated circuit formed thereon. The TV tuner 110 connects with a host computer (not shown) through a USB interface or is directly inserted into a PCI connector of a motherboard of the host computer. The TV tuner 110 connects with the antenna member 120 through the RF cable 130. The TV tuner 110, also, processes TV signals (RF signals) transmitted from the antenna member 120, and transmits the processed TV signals to the host computer to be displayed.

The antenna member 120 includes a main body 122, a receiver 121 extending from the main body 122, and an infrared receiver 123 arranged on the main body 122. The receiver 121 is configured for receiving the TV signals. The main body 122 is attached to the TV tuner 110 through the RF cable 130. The main body 122 is configured for transmitting the TV signals received from the receiver 121 to the TV tuner 110. The infrared receiver 123 is configured for receiving remote control signals sent out from a remote control device to perform remote control.

Since the antenna member 120 is generally arranged to be visible, the infrared receiver 123 arranged on the main body 122 is also visible and not generally blocked by other objects, such as the host computer, thus the infrared receiver 123 is in direct line of sight of the remote control signals. Therefore, the digital TV receiver 100 can enhance the capability of receiving the remote control signals.

Particular circuits of the digital TV receiver 100 in accordance with the preferred embodiment is described below.

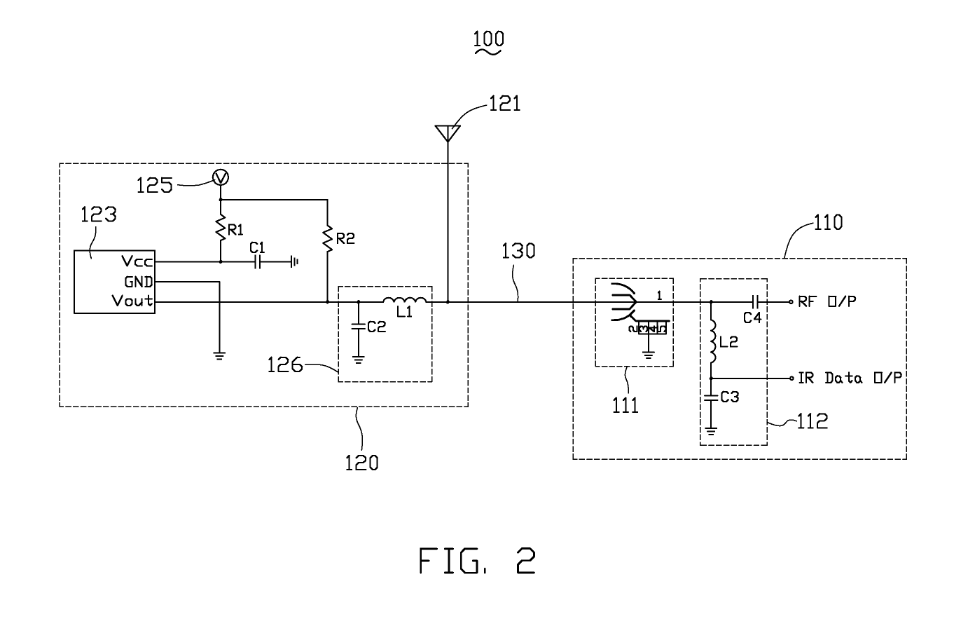

Referring to FIG. 2, a circuit diagram of the digital TV receiver 100 in accordance with a first preferred embodiment is shown. The antenna member 120 further includes a power supply 125 arranged therein. The power supply 125 is configured for supplying a working voltage to the infrared receiver 123. The power supply 125 does not supply the working voltage to the TV tuner 110. The power supply 125 may be a battery, a power adapter.

The antenna member 120 further includes a first low-pass filter 126, a first resistor R1, a first capacitor C1. The first low-pass filter 126 includes a first inductor L1 and a second capacitor C2. The power supply 125, the first resistor R1 and the first capacitor C1 are electrically connected together to form a loop. An input terminal Vcc of the infrared receiver 123 electrically connects to a first node defined between the first resistor R1 and the first capacitor C1 to receive the working voltage supplied by the power supply 125, and another terminal of the first capacitor C1 electrically connects to a ground. A grounding terminal GND of the infrared receiver 123 electrically connects to the ground. An output terminal Vout of the infrared receiver 123 electrically connects to a second node defined between the first inductor L1 and the second capacitor C2. Another terminal of the second capacitor C2 electrically connects to the ground. Another terminal of the first inductor L1 serves as an output terminal of the antenna member 120, which transmits the remote control signals received by the infrared receiver 123 to the TV tuner 110 through the RF cable 130. The receiver 121 also electrically connects to the RF cable 130 for transmitting the TV signals to the TV tuner 110. Preferably, the main body 122 further includes a second resistor R2 arranged between the power supply 125 and the second node defined between the first inductor L1 and the second capacitor C2. The second resistor R2 electrically connects to the output terminal Vout of the infrared receiver 123 and the power supply 125. The second resistor R2 is configured for ensuring the output terminal Vout of the infrared receiver 123 to produce an output voltage corresponding to the remote control signals.

The TV tuner 110 includes a RF connector 111 electrically connecting to the RF cable 130, and a second low-pass filter 112 configured for separating the output from the TV signals received from the receiver 121 and the remote control signals received from the infrared receiver 123. The second low-pass filter 112 includes a second inductor L2, a third capacitor C3, and a fourth capacitor C4. The RF connector 11I electrically connects to a third node defined between the second inductor L2 and the fourth capacitor C4. Another terminal of the fourth capacitor C4 serves as a first output terminal RF O/P (radio frequency output) of the digital TV receiver 100. The first output terminal RF O/P is configured for outputting the TV signals received from the receiver 121 of the antenna member 120. Another terminal of the second inductor L2 electrically connects to one terminal of the third capacitor C3, and another terminal of the third capacitor C3 electrically connects to the ground. A fourth node defined between the second inductor L2 and the third capacitor C3 serves as a second output terminal IR Data O/P (infrared data output) of the digital TV receiver 100. The second output terminal IR Data O/P is configured for outputting the remote control signals received from the infrared receiver 123.

In this exemplary embodiment, the antenna member 120 employs the power supply 125 configured for supplying the working voltage to the infrared receiver 123 such that the infrared receiver 123 may work independently to receive the remote control signals.

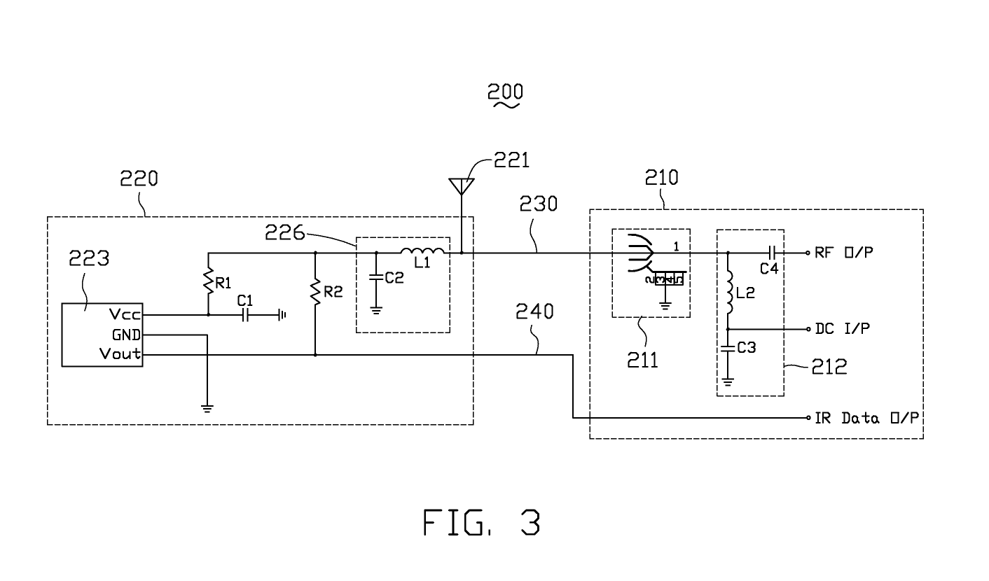

Referring to FIG. 3, a circuit diagram of a digital TV receiver 200 in accordance with a second preferred embodiment is shown. The circuit of the digital TV receiver 200 of the second preferred embodiment is similar to that of the first preferred embodiment, except that an antenna member 220 does not includes an independent power supply configured for supplying a working voltage to an infrared receiver 223. The infrared receiver 223 can be operated by supplying the working voltage from a TV tuner 210 through an RF cable 230.

The antenna member 220 includes a first low-pass filter 226, a first resistor R1 and a first capacitor C1. The first low-pass filter 226 includes a first inductor L1 and a second capacitor C2. An input terminal Vcc of the infrared receiver 223 electrically connects to a first node defined between the first resistor R1 and the first capacitor C1. Another terminal of the first capacitor C1 electrically connects to a ground, and another terminal of the first resistor R1 electrically connects to a second node defined between the second capacitor C2 and the first inductor L1. Another terminal of the second capacitor C2 electrically connects to the ground. Another terminal of the first inductor L1 serves as an input terminal of the antenna member 220, the another terminal of the first inductor L1 is configured for receiving the working voltage from the TV tuner 210 and transmitting the working voltage to the input terminal Vcc of the infrared receiver 223. A grounding terminal GND of the infrared receiver 223 electrically connects to the ground. An output terminal Vout of the infrared receiver 223 directly and electrically connects to a second output terminal IR Data O/P of the TV tuner 210 via a transmitting wire 240, for transmitting the remote control signals received from the infrared receiver 223 to the second output terminal IR Data O/P of the TV tuner 210. Preferably, the antenna member 220 further includes a second resistor R2 electrically connecting between the output terminal Vout of the infrared receiver 223 and the first node defined between the first inductor L1 and the second capacitor C2. The second resistor R2 is configured for ensuring the output terminal Vout of the infrared receiver 223 to produce an output voltage corresponding to the remote control signals. The receiver 221 of the antenna member 220 electrically connects to the RF cable 230 to be configured for transmitting the TV signals received from the receiver 221 to the TV tuner 210.

The TV tuner 210 includes a RF connector 211 electrically connecting to the RF cable 230, and a second low-pass filter 212. The second low-pass filter 212 includes a second inductor L2, a third capacitor C3 and a fourth capacitor C4. The RF connector 211 electrically connects to a third node defined between the second inductor L2 and the fourth capacitor C4. Another terminal of the fourth capacitor C4 serves as a first output terminal RF O/P of the digital TV receiver 200. The first output terminal RF O/P is configured for outputting the TV signals received from the receiver 221 of the antenna member 220. Another terminal of the second inductor L2 electrically connects to one terminal of the third capacitor C3, and another terminal of the third capacitor C3 electrically connects to the ground. A fourth node defined between the second inductor L2 and the third capacitor C3 serves as an input terminal DC I/P (direct current input) configured for transmitting the working voltage supplied from a power source of the TV tuner 210 to the infrared receiver 223.

In this exemplary embodiment, the digital TV receiver 200 employs the input terminal DC I/P to transmit the working voltage supplied from the power source of the TV tuner 210 to the infrared receiver 223, such that the infrared receiver 223 can be operated. The digital TV receiver 200 employs the first output terminal RF O/P to output the TV signals received from the receiver 221 of the antenna member 200. The digital TV receiver 200 further employs the second output terminal IR Data O/P electrically connecting to the output terminal Vout of the infrared receiver 223 via the transmitting wire 240, to output the remote control signals received from the infrared receiver 223.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An antenna member, comprising:
a main body;
a receiver extending from the main body configured for receiving TV signals;
an infrared receiver arranged in the main body configured for receiving remote control signals sent out from a remote device.

2. The antenna member as claimed in claim 1, further comprising a power supply arranged therein for supplying a working voltage to the infrared receiver.

3. The antenna member as claimed in claim 2, wherein the power supply is one of a battery and a power adapter.

4. The antenna member as claimed in claim 2, further comprising a first low-pass filter, a first resistor R1 and a first capacitor C1 arranged therein, the first low-pass filter including a first inductor L1 and a second capacitor C2, the power supply, the first resistor R1 and the first capacitor C1 being electrically connected together to form a loop, an input terminal Vcc of the infrared receiver connecting to a first node defined between the first resistor R1 and the first capacitor C1, another terminal of the first capacitor C1 electrically connecting to a ground, a grounding terminal GND of the infrared receiver electrically connecting to the ground, an output terminal Vout of the infrared receiver electrically connecting to a second node defined between the first inductor L1 and the second capacitor C2, another terminal of the second capacitor C2 electrically connecting to the ground, and another terminal of the first inductor L1 being served as an output of the antenna member configured for transmitting the remote control signals received from the infrared receiver.

5. The antenna member as claimed in claim 4, further comprising a second resistor R2 electrically connecting between the power supply and the output terminal Vout of the infrared receiver.

6. The antenna member as claimed in claim 1, further comprising a first low-pass filter, a first resistor R1 and a first capacitor C1 arranged in the main body, the first low-pass filter including a first inductor L1 and a second capacitor C2, an input terminal Vcc of the infrared receiver electrically connecting to a first node defined between the first resistor R1 and the first capacitor C1, another terminal of the first capacitor C1 electrically connecting to a ground, another terminal of the first resistor R1 electrically connecting to a second node defined between the first inductor L1 and the second capacitor C2, another terminal of the second capacitor C2 electrically connecting to the ground, another terminal of the first inductor L1 being served as an input of the antenna member configured for supplying a working voltage to the infrared receiver, a grounding terminal GND of the infrared receiver electrically connecting to the ground, and an output terminal Vout of the infrared receiver being served as an output of the antenna member configured for transmitting the remote control signals received from the infrared receiver.

7. The antenna member as claimed in claim 6, further comprising a second resistor R2 electrically connecting between the output terminal Vout of the infrared receiver and the second node defined between the first inductor L1 and the second capacitor C2.

8. A digital TV receiver, comprising:
a TV tuner;
a RF cable;
an antenna member electrically connecting to the TV tuner through the RF cable, the antenna member including a main body, a receiver extending from the main body configured for receiving TV signals and transmitting the TV signals to the TV tuner through the RF cable, an infrared receiver arranged in the main body configured for receiving remote control signals sent out from a remote device.

9. The digital TV receiver as claimed in claim 8, wherein the antenna member further includes a power supply arranged in the antenna member configured for supplying a working voltage to the infrared receiver, and the remote control signals received from the infrared receiver are transmitted to the TV tuner through the RF cable.

10. The digital TV receiver as claimed in claim 9, wherein the power supply is one of a battery and a power adapter.

11. The digital TV receiver as claimed in claim 9, wherein the antenna member further includes a first low-pass filter, a first resistor R1 and a first capacitor Cl arranged therein, the first low-pass filter includes a first inductor L1 and a second capacitor C2; the TV tuner includes a RF connector connected to the RF cable, a second low-pass filter connected to the RF connector, the second low-pass filter includes a second inductor L2, a third capacitor C3 and a fourth capacitor C4; the power supply, the first resistor R1 and the first capacitor C1 are electrically connected together to form a loop, an input terminal Vcc of the infrared receiver electrically connects a first node defined between the first resistor R1 and the first capacitor C1, another terminal of the first capacitor C1 electrically connects to a ground, a grounding terminal GND of the infrared receiver electrically connects to the ground, an output terminal Vout of the infrared receiver electrically connects to a second node defined between the first inductor L1 and the second capacitor C2, another terminal of the second capacitor C2 electrically connects to the ground, and another terminal of the first inductor L1 electrically connects to a third node defined between the second inductor L2 and the fourth capacitor C4 of the TV tuner through the RF cable and the RF connector, the receiver also electrically connects to the third node defined between the second inductor L2 and the fourth capacitor C4 of the TV tuner through the RF cable and the RF connector, another terminal of the fourth capacitor C4 is served as a first output of the digital TV receiver configured for outputting the TV signals received from the receiver, another terminal of the second inductor L2 electrically connects to one terminal of the third capacitor C3, another terminal of the third capacitor C3 electrically connects to the ground, and a fourth node defined between the second inductor L2 and the third capacitor C3 is served as a second output terminal of the digital TV receiver configured for outputting the remote control signals received from the infrared receiver.

12. The digital TV receiver as claimed in claim 11, wherein the antenna member further includes a second resistor R2 electrically connecting between the power supply and the output terminal Vout of the infrared receiver.

13. The digital TV receiver as claimed in claim 8, wherein an input terminal Vcc of the infrared receiver obtains a working voltage from the TV tuner through the RF cable, and an output terminal Vout of the infrared receiver electrically connects to a transmitting wire served as a second output terminal of the TV tuner configured for outputting directly the remote control signals received from the infrared receiver.

14. The digital TV receiver as claimed in claim 13, wherein the antenna member further includes a first low-pass filter, a first resistor R1 and a first capacitor C1 arranged therein, the first low-pass filter includes a first inductor L1 and a second capacitor C2; the TV tuner includes a RF connector electrically connecting to the RF cable, a second low-pass filter electrically connecting to the RF connector, the second low-pass filter includes a second inductor L2, a third capacitor C3 and a fourth capacitor C4; the input terminal Vcc of the infrared receiver electrically connects to a first node defined between the first resistor R1 and the first capacitor C1, another terminal of the first capacitor C1 electrically connects to a ground, another terminal of the first resistor R1 electrically connects to a second node defined between the first inductor L1 and the second capacitor C2, another terminal of the second capacitor C2 electrically connects to the ground, and another terminal of the first inductor L1 electrically connects to a third node defined between the second inductor L2 and the fourth capacitor C4 of the TV tuner through the RF cable and the RF connector, the receiver also electrically connects to the third node defined between the second inductor L2 and the fourth capacitor C4 of the TV tuner through the RF cable and the RF connector, another terminal of the fourth capacitor C4 is served as a first output of the digital TV receiver configured for outputting the TV signals received form the receiver, another terminal of the second inductor L2 electrically connects to one terminal of the third capacitor C3, another terminal of the third capacitor C3 electrically connects to the ground, and a fourth node defined between the second inductor L2 and the third capacitor C3 is served as an input terminal of the digital TV receiver configured for supplying a working voltage to the input terminal Vcc of the infrared receiver, a grounding terminal GND of the infrared receiver electrically connects to the ground, and the output terminal Vout of the infrared receiver electrically connects to the transmitting wire configured for transmitting the remote control signals to the TV tuner.

15. The digital TV receiver as claimed in claim 14, wherein the antenna member further includes a second resistor R2 electrically connecting between the output terminal Vout of the infrared receiver and the second node defined between the first inductor L1 and the second capacitor C2.
